(19) United States
(12) Patent Application Publication
(10) Pub. No.: US 2007/0016508 A1
(43) Pub. Date: Jan. 18, 2007

(54) Method and system for redeemable vouchers using an insurance model

(76) Inventors: Pierre Lapointe, Vancouver (CA); Howard Olsen, Vancouver (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/181,889

(22) Filed: Jul. 15, 2005

(51) Int. Cl. G06Q 40/00

(52) U.S. Cl. 705/37

(57) ABSTRACT

A method for redeeming a merchant-issued voucher having a potential future value and redeemable during a voucher redemption period is provided. A merchant provides voucher issuance information and merchant fees for a voucher redemption period. During an investment period, an investment amount is invested representing a percentage of the merchant fees, in order to generate an investment revenue amount. Following the investment period, a total redeemable amount is received for the voucher redemption period, representing the investment amount and a percentage of the investment revenue amount. During the voucher redemption period, for at least some of the issued vouchers, receiving a voucher claim for the potential future voucher value and processing the voucher claim using the voucher issuance information, to pay out, from the total redeemable amount, a payout amount up to the potential future voucher value.

### FIELD OF THE INVENTION

The invention relates to field of merchant-issued redeemable vouchers. More specifically, it relates to a method and system allowing merchants to issue redeemable vouchers having a future potential value.

### BACKGROUND OF THE INVENTION

Mail-in rebates and similar types of vouchers have been used for some time as an alternate to store discounts or coupons to efficiently motivate customers to purchase goods and/or services. A typical mail-in voucher system provides buyers with the opportunity of receiving a voucher of a predetermined value, within a predetermined period of time following a purchase, by submitting a voucher claim. The advantage of mail-in vouchers to the consumer is that mail-in vouchers give the consumer confidence as to the final price they pay. De facto, consumers acquire an option for a better price to be effected at a later date.

The inconvenience associated with such mail-in vouchers is that submission of a voucher claim is time-consuming and further requires the consumer to keep track of purchase receipts and other product/service purchase proofs, such as the Universal Product Code (UPC) of a product package. Consumers also need to fill out paperwork associated with the claim submission and mail it, etc. Some consumers do no not want to do such paperwork and their purchasing decisions are not influenced by the availability of such mail-in vouchers.

Consumers choose to effect this option based on the value of the leisure time required to complete the mail-in paperwork. Often consumers elect to forgo their option for a better price as they value more their leisure time than the value of the mail-in voucher.

Mail-in vouchers systems are advantageously used by merchants to retain a higher portion of their margins than with discounts. While discounts reduce the profit margin on all purchases to which the discount applies, mail-in vouchers apply only to those purchases for which the consumer elects to redeem the voucher.

Mail-in vouchers have been used traditionally for relatively small sales and small vouchers amounts. Merchants who market “big ticket” items have a need for large amount mail-in vouchers, but current large amount redeemable voucher systems suffer from numerous drawbacks.

For example, existing large amount mail-in vouchers implement trust funds as a means of ensuring that the voucher amounts will be available for redemption at the time the claims are made. These services have generally failed to provide reassurance to merchants, consumers and regulators as to the likelihood of the large mail-in vouchers being honored. This is due to the fact that, traditionally, only a small percentage of the total value of the vouchers is placed in the trust fund, the risk being that at the time of redemption more claimants that anticipated will seek to redeem the voucher.

It has been observed that the redemption rate of large amount redeemable vouchers remains constant if the time horizon is increased proportionally to the value of the redeemable voucher. Furthermore, it has been observed that such redemption rates were similar to claim submissions in the insurance industry. Hence, voucher claim submissions can be modeled using mathematical formulae and business tools developed for the insurance industry.

There exists therefore a need for a large amount redeemable voucher system that would allow merchants to provide large amount redeemable vouchers on large amount sales with confidence that buyers will receive the appropriate voucher amount at claim time.

There exists a need for a system that would allow consumers to trust the predictability of the outcome of large amount redeemable vouchers.

Furthermore, there exists a need for a large amount redeemable voucher system that would be transparent and predictable so as to comply with regulators' examinations.

### SUMMARY OF THE INVENTION

Accordingly, an object of the present invention is to provide a system and method allowing merchants to provide large amount redeemable vouchers that guarantee that buyers receive an appropriate rebate amount at claim time.

It is another object of the present invention to provide a system and method for providing large amount redeemable rebates on purchases that is transparent and predictable by implementing an insurance model.

It is another object of the present invention to use insurance tools and actuarial studies of attrition rates of large amount redeemable vouchers in order to predict more accurately the financial outcome of redeemable vouchers for merchants, consumers and regulators.

According to a first broad aspect of the present invention, there is provided a method for redeeming a merchant-issued voucher having a potential future value and redeemable during a voucher redemption period, comprising: receiving from the merchant voucher issuance information; receiving from the merchant, merchant fees; during an investment period, investing an investment amount representing a percentage of the merchant fees, in order to generate an investment revenue amount; following the investment period, receiving a total redeemable amount for the voucher redemption period, representing the investment amount and a percentage of the investment revenue amount; during the voucher redemption period, for at least some of the issued vouchers, receiving a voucher claim for the potential future voucher value; and processing the voucher claim using the voucher issuance information, to pay out, from the total redeemable amount, a payout amount up to the potential future value.

According to a second broad aspect of the present invention, there is provided a system for redeeming merchant-issued vouchers having a potential future value and redeemable during a voucher redemption period, comprising: a voucher registration unit for receiving voucher issuance information; a voucher program storage unit for recording the voucher issuance information; a funds management unit for receiving merchant fees and for distributing a total redeemable amount as a payout amount to voucher recipients; a risk management unit for providing a risk assessment associated with redeeming the potential future value for the vouchers during the voucher redemption period; an insurance unit receiving an investment amount as a percentage of the merchant fees for investment in accordance with the risk assessment and providing, at the end of an investment period, the investment amount and an investment revenue amount to the funds management unit; and a claim processing unit receiving claims for at least some of the merchant-issued vouchers and determining the payout amount up to the potential future value.

### BRIEF DESCRIPTION OF THE DRAWINGS

These and other features, aspects and advantages of the present invention will become better understood with regard to the following description and accompanying drawings wherein:

FIG. 1 is a block diagram of merchants and buyers interacting with the system for redeemable vouchers according to the present invention;

FIG. 2 is a block diagram of a system for redeemable vouchers using an insurance model according to the present invention;

FIG. 3 is a graph of the voucher redemption rate vs. the voucher time horizon according to risk assessment analysis used in the present invention;

FIG. 4 is a timeline of voucher events from issuance to redemption according to the present invention; and

FIG. 5 is a flow chart of a method for redeeming a voucher having a potential future value according to the present invention.

### DETAILED DESCRIPTION OF THE PREFERRED EMBODIMENT

The present invention relates to a method and system for redeeming merchant-issued vouchers having a potential future value.

In a preferred embodiment of the present invention, an insurance industry model is applied to the system and method of the present invention by: risk management professionals measuring accurately the voucher claim submission rates and using mathematical formulae to predict future claim submission rates; locking fees received from merchants into insurance policies contracted with an insurance company; and an independent claims adjuster processing and validating submitted voucher claims.

The invention will now be described with reference to the figures wherein same numerals indicate same elements in all figures.

In the description of the present invention, a redeemable voucher will designate a certificate issued to a buyer in conjunction to a purchase transaction from a merchant. The certificate has a potential future value in that it provides to the voucher recipient the possibility of redeeming the certificate at a point in the future in exchange for a potential value. The potential value represents a maximum value that a voucher recipient may receive according to the method and system of the present invention following submission of a voucher claim and following the terms and conditions of the voucher program. As used herein below, the potential future value of the voucher may be a monetary value, as well as a good or service or a value thereof.

The time between the voucher issuance date, which coincides with the purchase transaction date, and the beginning of the voucher redemption period, will be referred to as the “voucher time horizon”. The period during which a claim can be submitted for redeeming the value of a voucher will be referred to as a “voucher redemption period”. For example, and as illustrated in FIG. 4, the voucher recipient can submit a claim to redeem the potential value of the voucher following a voucher time horizon, over the course of a voucher redemption period. In the preferred embodiment of the present invention, the voucher time horizon could be 3 years from the voucher issuance date and the voucher redemption period could be a week.

A buyer is a consumer who purchases goods and/or services from a merchant. A voucher recipient is a buyer of goods and/or services for which the merchant has made available a voucher offer and who receives a voucher from the merchant at the time of the purchase transaction. Finally, a voucher claimant is a voucher recipient who submits a voucher claim in order to redeem the potential future value of the voucher. The terms “buyer”, “voucher recipient” and “voucher claimant” are used interchangeably in the following description.

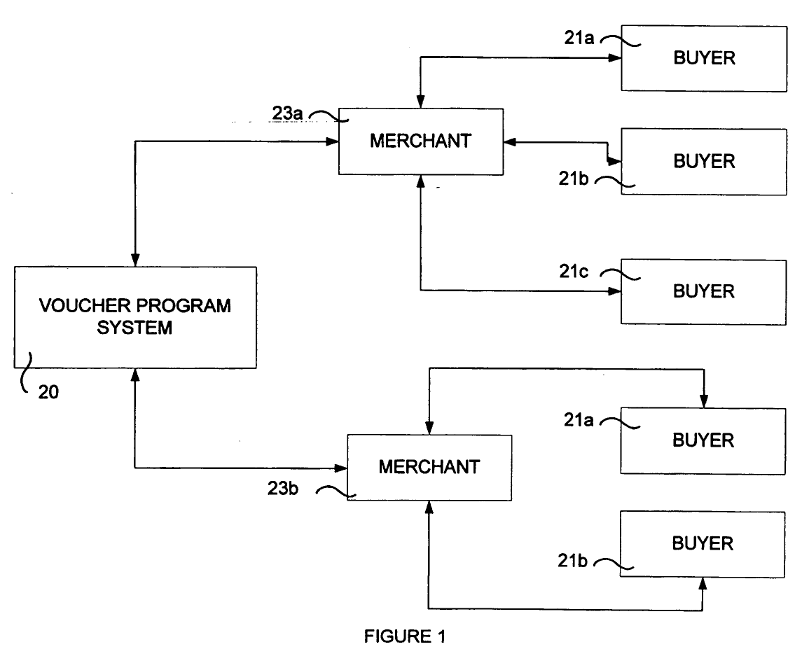

Referring to FIG. 1, which illustrates a plurality of merchants 23 subscribing to the voucher program system 20 of the present invention, vouchers are issued to a plurality of buyers 21, at the time of a purchase transaction.

The merchants 23 participating in the voucher program enter into an agreement with the voucher program system 20 for providing the redeemable vouchers to buyers 21. The agreement between a merchant 23 and the voucher program system 20 preferably defines the amounts of merchant fees to be paid and the voucher issuance information to be provided to the system 20.

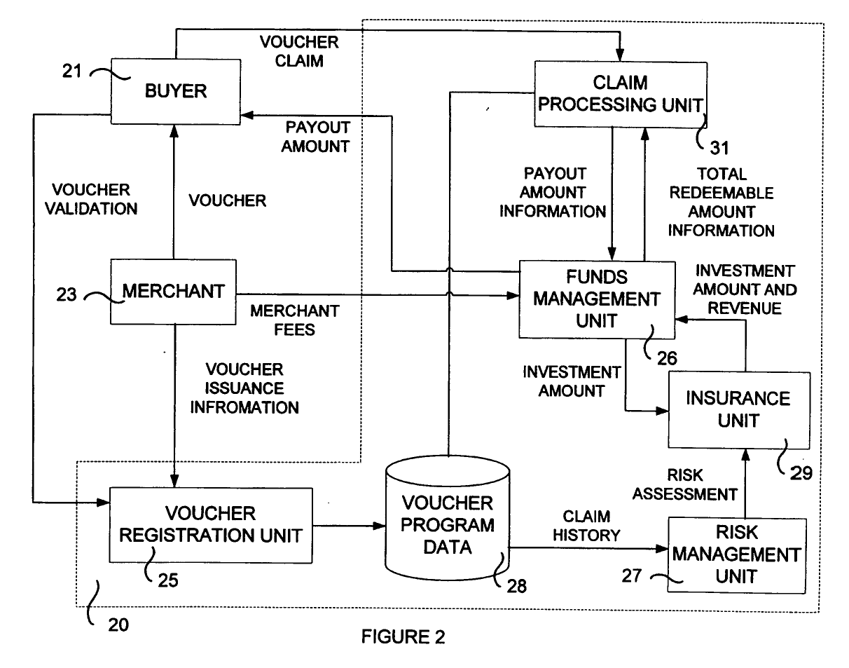

Now, with respect to FIG. 2, a preferred embodiment of the system for redeeming vouchers having a potential future value will be described.

While the description will be made with respect to a single merchant system 23, it should be understood that the system and method of the present invention is preferably applied to a plurality of merchants issuing vouchers to a plurality of buyers having a same voucher redemption period.

At the time of a purchase transaction, a merchant 23 distributes to a buyer 21, a voucher having a potential future value. In one embodiment of the present invention, the vouchers are provided to the merchant 23 by the voucher program system 20 at the time of entering into the agreement with the voucher program system 20. In alternative embodiments, the vouchers may be merchant-specific vouchers issued by the merchant 23.

The system and method according to the present invention can be applied to a variety of sale transactions, such as transactions for goods/services sold in a store, by mail, over the telephone, on-line, etc. It will be therefore understood by those skilled in the art that the present invention is not to be limited to a particular implementation and that any system for purchasing goods/services is within the scope of the present invention.

The issuance of the voucher to the buyer-21 involves recording voucher identification information and purchase transaction information. The voucher identification information preferably includes a voucher serial number or other unique identification means for the voucher. The purchase transaction information preferably includes buyer identification, such as a buyer name or a buyer membership number (if the buyer is enrolled as a member of a merchant loyalty program), but may be any other unique buyer identification means. Preferably, the buyer identification information includes buyer contact information, such as address, telephone number, email address, etc. The purchase transaction information further preferably includes a description of the goods/services purchased and the value of the purchase transaction.

The voucher issuance information is recorded at a point-of-sale system associated with the merchant 23, according to methods for processing purchase transactions well-known to those skilled in the art. Data may be entered either manually by a merchant employee or automatically using barcode scanning techniques. The purchase transaction information preferably includes a unique purchase transaction serial number allowing the tracking of the transaction in the system. In the case in which the purchase transaction is an online purchase transaction, the voucher issuance information is similarly generated and recorded by a merchant server (not shown) and transmitted to the buyer through a secure communication session, according to methods well-known to those skilled in the art.

The potential future value of the voucher is assigned thereto at the time of the purchase transaction. In a preferred embodiment of the present invention, the potential future value of the voucher is related to the value of the purchase transaction. For example, in one embodiment of the present invention, the issued voucher has a large amount potential future value, without exceeding 75% of the value of the purchase transaction or $10,000, whichever is lower. Alternatively, the redeemable potential future value of the voucher may be a fixed amount independent of the value of the purchase transaction.

Merchant system 23 includes a purchase transaction recording system, a storage system and is in communication with the voucher registration unit 25 of the voucher program system 20.

The voucher registration unit 25 receives voucher issuance information from merchants 23 and provides the information to a storage unit. With respect to FIG. 2, the voucher program database 28 is an exemplary storage unit for storing voucher identification information and purchase transaction information received from merchants 23 subscribing to the voucher program. The information is transferred between the merchant system 23 and the voucher registration unit 25 electronically through a computer network, such as a private LAN/WAN network, or a public network, such as the Internet. The transfer of information between the merchant system 23 and the voucher registration unit 25 may take place at the time of the purchase transaction or any time thereafter. Preferably, information for all purchase transactions of a same day is transferred at the end of the day or according to another periodic basis. The merchant system 23 and the voucher registration unit 25 may communicate via any suitable transmission media, such as an ordinary public telephone line, a data quality line, a radio link or any other transmission media suitable for inter-computer communication.

The voucher program system 20 further comprises a funds management unit 26, which controls the transfer and allocation of funds between the different units of the system 20 throughout the lifetime of a voucher, from issuance to redemption. The funds management unit 26 receives, from each merchant 23 affiliated to the voucher program, merchant fees, in accordance with the terms of the agreement between the merchant and the voucher program system 20. In one embodiment of the present invention, the merchant fees might represent a percentage of the total value of vouchers issued by the merchant. For example, in a preferred embodiment of the present invention, the merchant fees received from a single merchant 23 represent 15% of the potential future value of all vouchers issued by the merchant 23 and having a same voucher redemption period.

Alternatively, the merchant fees may be a fixed amount, as defined by the agreement between the merchant and the voucher program system 20.

In a preferred embodiment of the present invention, the funds management unit 26 administers the use of the merchant fees and their distribution according to generally accepted insurance industry practice. Still in accordance with a preferred embodiment of the present invention, the merchant fees are distributed as follows: 10% of the merchant fees is distributed to general and administrative expenses of the voucher program, 30% of the merchant fees is awarded to marketing expenses and 50% is provided, as an investment amount to an insurance unit 29. Another 10% percentage is provided to cover the risk management unit 27 management fees, claim adjustment costs and applicable insurance taxes.

The funds management unit 26 also receives from the insurance unit 29 the investment amount and investment revenue. These funds are again distributed, with a first amount being made available as a total redeemable amount for covering voucher claims for a specific voucher redemption period and a second amount being returned to the insurance unit 29 to cover the insurance unit 29 administrative fees and/or other fees.

In a preferred embodiment of the present invention, the insurance unit 29 is a captive insurance company. Using a captive insurance company provides the advantage of a strong regulatory environment that protects and reassures the consumer, since the funds set aside for claim redemption become subject to insurance rules and regulations of the country in which the captive insurance company is located. Using a captive insurance program also ensures that proper actuarial tools are used to measure voucher redemption rates and as such, opens the door to future buying of re-insurance in order to increase the certainty of payment to voucher claimants.

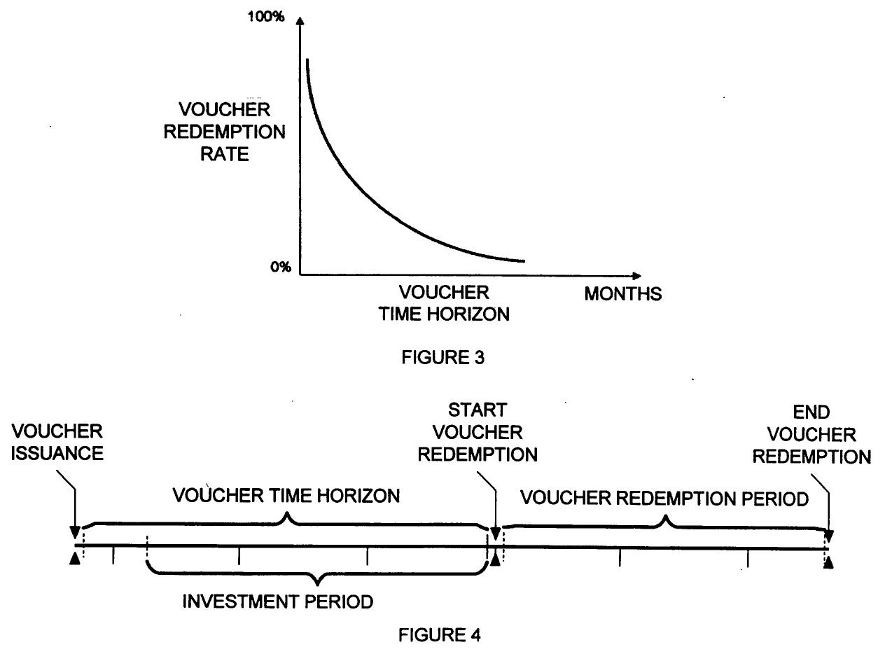

The risk management unit 27 provides risk assessments to the insurance unit 29. The risk management unit 27 measures voucher claim submission rates (claim history) and uses mathematical formulae and models to predict future voucher claim submission rates. The risk management unit also gathers information from other sources, such as consumer behaviour studies with respect to the factors that influence voucher claim submission (redemption rates), i.e. consumer income level, education level, voucher time horizon, voucher potential future value, etc. For example, with respect to FIG. 3, there is shown the relationship between the voucher redemption rate and the voucher time horizon, indicating the decline in voucher redemption rates associated with an increase in the voucher time horizon. The behaviour of the voucher redemption rate appears to decrease, independently of the future potential value of the voucher, as the voucher time horizon is increased. FIG. 3 represents an exemplary tool for analysis of historical voucher claim submission data used by the risk management unit 27. The shape of the redemption curve shown in FIG. 3 can be influenced and the corresponding change measured if the issuer changes the conditions for voucher redemption by adding levels of complexity to the process.

The risk management unit 27 makes recommendations for the insurance and the claim adjustment parts of the voucher redemption program. Furthermore, the risk management unit 27 ensures that the insurance unit 29 and the claim processing unit 31 conform to all regulatory requirements specific to the insurance industry. The risk management unit 27 is the liaison with insurance industry regulators on behalf of the program.

The risk management unit 27 also gathers information regarding submitted voucher claims with the purpose of establishing actuarial data that could be used to buy other insurance services to enhance the outcome of the program for the consumers and therefore merchants. For example, the risk management unit 27 may identify trends in voucher redemption rates that may require a change in, the merchants' fees or in the terms and conditions of the vouchers. The risk management unit 27 uses such analysis to detect fraudulent behavior from merchants 23 or buyers 21 and may recommend changes to the merchants' fees or to the terms and conditions to prevent such behavior.

The insurance unit 29 receives an investment amount from the funds management unit 29 and a risk assessment from the risk management unit 27 and makes investments accordingly over an investment period. The investment period, as shown in FIG. 4, coincides with the voucher time horizon and expires at the beginning of the voucher redemption period. In a preferred embodiment of the present invention, the voucher time horizon might be a period of 3 years following the voucher issuance. The insurance unit 29 might, in this case, invest the investment amount and after 3 years, return the investment amount and the return on investment to the funds management unit 26. The risk assessment received from the risk management unit 27 is used in order to define parameters such as investment risk, investment period and a target investment return rate.

The claim processing unit 31 receives and processes voucher claims submitted by voucher recipients. Voucher claims are processed at the end of the voucher time horizon for redeeming the future potential value of the vouchers. A voucher recipient may submit a claim by submitting the original voucher and proofs of purchase and filling out a paper form using traditional mail. Alternatively, the voucher recipient may submit a claim electronically, by entering the claim information on a designated website of the voucher program system 20. It will be understood that a plurality of other ways to submit voucher claims are possible, and as such fall under the scope of the present invention.

The voucher claim submission involves the voucher recipient transmitting information such as voucher identification information and purchase transaction information. The voucher identification information is preferably the voucher serial number and the purchase transaction information is the information provided by the point of sale system at the time of the purchase transaction.

The information submitted by the voucher recipient and received by the claim processing unit 31 is used to retrieve the corresponding voucher record from the voucher program database 28 and match it with the information provided in the voucher claim. For example, computerized software could be used to verify that the purchase transaction information stored in the voucher program database 28, and associated with a given voucher serial number, is the same as the purchase transaction information submitted in the voucher claim. Similarly, if a voucher recipient identification has been provided at the time of the purchase transaction, the voucher recipient identity submitted in the claim is verified. A correct match for any or all of the matching criteria allows the claim processing unit 31 to validate the voucher claim and to proceed with determining the appropriate claim payout amount.

The funds management unit 26 provides to the claim processing unit 31 information regarding the total redeemable amount available following the investment period. From all the valid voucher claims received, the claim processing unit 31 determines the total amount claimed for a given voucher redemption period. More specifically, the total amount claimed for a given voucher redemption period is the sum of all potential future values of vouchers having the same voucher redemption period.

With respect to determining the payout amount and as it has been described hereinabove, the future potential value of each issued voucher represents a maximum redeemable amount. Using a principle similar to co-insurance that covers insufficient premiums payment, the exact amount represented by the future potential value is redeemed only if the total redeemable amount available for a given voucher redemption period is sufficient to cover the total amount claimed for that voucher redemption period.

For example, if the total redeemable amount is $100,000 and the total amount claimed is $50,000 for 50 vouchers having each a potential future value of $1,000, then all 50 voucher recipients receive a payout amount of $1,000.

If the total redeemable amount does not cover the total amount claimed for the voucher redemption period, the payout amount received by each voucher recipient is determined by the claim processing unit 31 according to a payout rate. In a preferred embodiment of the present invention, the payout rate is calculated as follows:
Payout Rate (%)=(Total Redeemable Amount/Total Amount Claimed)*100

The payout amount is determined as:
Payout Amount=Payout Rate*Potential Future Value

For example, if the total redeemable amount is $40,000 and the total amount claimed is $50,000 for 20 vouchers having each a potential future value of $1,000 and 6 vouchers having a potential future value of $5,000, then the payout rate is calculated according to the formula:
Payout Rate=40,000/50,000=80%

For the vouchers having a potential future value of $1,000, the payout amount is:
Payout Amount=80%*$1,000=$800.

While for the vouchers having a potential future value of $5,000, the payout amount is:
Payout Amount=80%*$5,000=$4,000.

Once the payout amount information has been calculated for each voucher claim, the information is provided to the funds management unit 26, so that voucher claimants may receive the appropriate payout amount.

The payout amount may be provided to the voucher claimants as a check, a credit made to a bank account or to a credit account or as a certificate redeemable against other goods and/or services provided by any of the merchants 23 participating in the voucher program.

In one embodiment of the present invention, in the case in which the total redeemable amount exceeds the total amount claimed for a given voucher redemption period, the surplus difference may be transferred to the total redeemable amount of a different voucher redemption period. Similarly, the surplus difference from the operations of a voucher program system 20 in a given geographical area may be transferred to the total redeemable amount of a different geographical area.

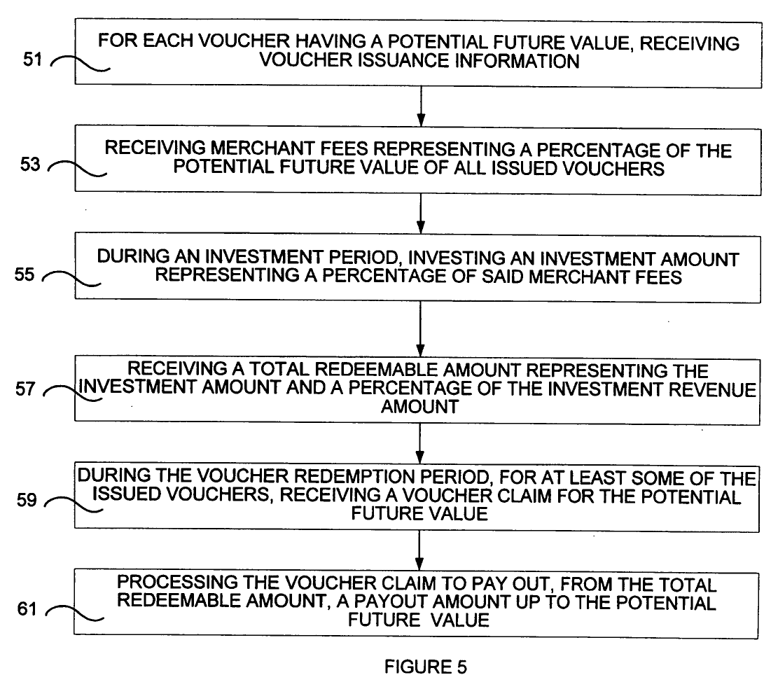

Now, with respect to FIG. 5, a method for redeeming merchant-issued vouchers having a potential future value will be described.

Following a merchant issuing vouchers having a potential future value, in step 51, for each voucher, receiving voucher issuance information. In a next step 53, merchant fees are received from the merchant. In a preferred embodiment, the merchant fees represent a percentage of the potential future value of all vouchers issued by the merchant. Then, in step 55, during an investment period, an investment amount representing a percentage of the received merchant fees is invested. In a preferred embodiment of the present invention, the investment is made in accordance with a risk assessment associated with redeeming said potential future value for said vouchers during said voucher redemption period.

In step 57, a total redeemable amount representing the investment amount and a percentage of the investment revenue amount is received. In step 59, during a voucher redemption period, for at least some of the issued vouchers, a voucher claim for the potential future voucher value is received. In step 61, the voucher claim is processed using the voucher issuance information, to pay out, from the total redeemable amount, a payout amount up to the potential future value of the voucher.

As an optional step (not shown), depending on the terms and conditions of the voucher redemption agreement, voucher recipients may be required to validate the voucher during a defined voucher validation period, prior to submitting a voucher claim. In that case, processing the voucher claim includes verifying that the voucher has been validated during the appropriate voucher validation period.

Another optional step (not shown) is that of acquiring re-insurance protection for a given voucher redemption period in order to guarantee a minimum total redeemable amount. Such a re-insurance policy would be secured for voucher redemption periods for which it is determined, following a claim submission history analysis, that the total redeemable amount may be too low with respect to the forecasted total amount claimed. For example, once actuarial tables are established from studying the claim submission history, the risk management unit 27 may recommend using a portion of the merchant fees to secure, on behalf of the captive insurance company, re-insurance specific for the program. This re-insurance would transfer the risk of insufficient funds for various voucher redemption periods to an insurance company who would supplement the merchant fees in case of deficiency for a specific voucher redemption period.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A method for redeeming a merchant-issued voucher having a potential future value and redeemable during a voucher redemption period, comprising:
receiving from said merchant voucher issuance information;
receiving from said merchant merchant fees;
during an investment period, investing an investment amount representing a percentage of said merchant fees, in order to generate an investment revenue amount;
following said investment period, receiving a total redeemable amount for said voucher redemption period, representing said investment amount and a percentage of said investment revenue amount;
during said voucher redemption period, for at least some of said issued vouchers, receiving a voucher claim for said potential future voucher value; and
processing said voucher claim using said voucher issuance information, to pay out, from said total redeemable amount, a payout amount up to said potential future value.

2. A method as claimed in claim 1, wherein said processing said voucher claim comprises:
from all claims received, calculating a total claimed amount for said voucher redemption period;
if said total redeemable amount is less than said total claimed amount,
calculating a payout rate as a ratio between said total redeemable amount and said total claimed amount;
determining said payout amount according to said payout rate;
if said total redeemable amount exceeds said total claimed amount, for each of said claims, determining said payout amount to equal said potential future voucher value.

3. A method as claimed in claim 1, wherein said voucher issuance information includes voucher identification information and purchase transaction information, and wherein said processing said voucher claim further comprises:
matching said voucher identification information and said purchase transaction information provided by said merchant with information submitted with said voucher claim.

4. A method as claimed in claim 1, wherein a difference between said investment amount and said merchant fees represents an administrative fee.

5. A method as claimed in claim 2, wherein if said total redeemable amount exceeds said total claimed amount, a difference is added to a total redeemable amount of a different voucher redemption period.

6. A method as claimed in claim 1, further comprising:
receiving a validation of said vouchers following issuance;
and wherein said processing said voucher claim includes verifying whether a validation for said voucher has been received.

7. A method as claimed in claim 1, wherein said merchant is one of a plurality of merchants issuing vouchers and wherein said total voucher value claimed includes issued vouchers redeemable during a same voucher redemption period originating from all merchants.

8. A method as claimed in claim 1, further comprising:
acquiring insurance coverage for a given voucher redemption period in order to guarantee a minimum total redeemable amount.

9. A method as claimed in claim 1, further comprising:
receiving a risk assessment associated with redeeming said potential future value for said vouchers during said voucher redemption period and
wherein said investing said investment amount is done according to said risk assessment.

10. A method as claimed in claim 1, wherein said merchant fees represent a percentage of said potential future value of all vouchers issued by said merchant

11. A system for redeeming merchant-issued vouchers having a potential future value, comprising:
a voucher registration unit for receiving voucher issuance information;
a voucher program storage unit for recording said voucher issuance information;
a funds management unit for receiving merchant fees and for distributing a total redeemable amount as a payout amount to said voucher recipients;
a risk management unit for providing a risk assessment associated with redeeming said potential future value for said vouchers during said voucher redemption period;
an insurance unit receiving an investment amount as a percentage of said merchant fees for investment in accordance with said risk assessment and providing, at the end of an investment period, said investment amount and an investment revenue amount to said funds management unit; and
a claim processing unit receiving claims for at least some of said merchant-issued vouchers and determining said payout amount up to said potential future voucher value.

12. A system as claimed in claim 11, wherein said risk management unit and said claim processing unit are a single unit.

13. A system as claimed in claim 11, wherein said insurance unit comprises a captive insurance company.

14. A system as claimed in claim 11, further comprising a reinsuring unit providing insurance protection for a given voucher redemption period in order to guarantee a minimum total redeemable amount.
